(19) United States
(12) Patent Application Publication
(10) Pub. No.: US 2008/0313858 A1
(43) Pub. Date: Dec. 25, 2008

(54) DETACHABLE EXTENSION HANDLE

(76) Inventor: Dan Blom, Paramount, CA (US)

Correspondence Address: MARC E. HANKIN, ESQ., 11414 THURSTON CIRCLE, LOS ANGELES, CA, 90049, US

(21) Appl. No.: 11/766,789

(22) Filed: Jun. 21, 2007

(51) Int. Cl. B25G 3/00

(52) U.S. Cl. 16/427; 29/242

(57) ABSTRACT

Various embodiments of this invention are directed toward detachable extension handles that allow extension handles to be effortlessly and securely attached to implements of various types. Various embodiments of the invention feature a pin lock that is configured in a sloped, oval shape such that the extension handle may be easily attached to implement handles of various types.

### FIELD OF INVENTION

Various embodiments of this invention relate, generally, to extension handles; more particularly, to detachable extension handles with enhanced connecting mechanisms that allow the extension handle to be easily attached to and removed from an implement such as a mop, broom, tool, or similar such implement.

### BACKGROUND

Numerous mechanisms are known in the art for attaching extension handles to implements such as mops, brooms, tools, and similar such devices. Two of the desirable features for such mechanisms are that they allow the extension handle to securely attach to the implement and that they allow the quick and easy attachment and removal of the extension from the implement.

U.S. Pat. No. 1,483,435 to Hammer, for example, discloses a detachable handle that attaches to another implement by an aperture on the handle that engages with a fastener. Then, in order to remove Hammer's detachable handle, one loosens the fastener and releases the handle from the implement. In this manner, the handle may be added to and removed from other implements. The device, however, requires the use of additional tools, such as a screw driver or wrench in order to loosen the fastener, which may be undesirable in many circumstances.

Another such mechanism is disclosed by U.S. Pat. No. 3,425,756 to Hubbard. Hubbard's patent discloses a detachable extension handle that is also extensible. The extension handle uses a pin lock in order to connect the extension handle to an implement. The pin lock in Hubbard's device comprises a round symmetrical and generally cylindrically shaped button that is spring-loaded, such that when depressed, the button returns to its natural position. Like other pin locks, the button engages with an aperture in order to connect the extension handle to an implement. Hubbard improves upon other devices in the art by featuring a plurality of apertures at different distances along the implement. Thus, by selecting a given aperture, the user may select the desired length of the extension.

Like other pin lock mechanisms, however, the Hubbard's mechanism suffers from many shortcomings, making it undesirable to use in certain applications. First, in order to attach the extension handle to an implement, a user must depress the button, thereby requiring additional effort. The implement cannot be attached easily or with one hand. Also, in cases where the implement, such as a mop or paint brush, may be dirty or contaminated, it is often times undesirable to hold the implement because the dirt or contamination is transferred to the user's hands. Also, the circular shape of the pin lock is not conducive to easy attachment to and removal from the implement.

Another such mechanism is disclosed by U.S. Pat. No. 4,466,377 to Kolb et al. Kolb discloses a device for fastening handles to implements by a button activated locking insert. An extension is attached to a handle by, first, inserting the implement to an opening in the handle. Within the handle, a leaf spring engages with a hole in the implement in order to lock the handle onto the implement. The mechanism also features a push-button that is depressed from the outside of the handle in order to release the leaf spring and the implement from the handle.

A similar such mechanism is disclosed by U.S. Pat. No. 6,378,400 to Bogli. Bogli's patent discloses a detachable handle socket ratchet system that allows the user to change handles to suit the needs of the user. The coupling system, that attaches the handle to the ratchet, comprises a hinged and spring-loaded retaining pin at the handle that engages with a groove at the ratchet. The retaining pin disclosed by Bogli improves upon other related art systems by being generally sloped towards the distal end of the lever. In order to remove the handle from the ratchet, a button is pressed by the user, depressing the retaining pin from the groove, and allowing the handle to be removed.

Another such mechanism is disclosed by U.S. Patent Application No. 2003/0135950 to Dove. Dove's patent application discloses a mechanism for connecting a paint brush handle to an extension pole by a spring button device. Like the above patents, however, Dove fails to disclose a mechanism whereby the extension handle may easily be attached to the implement without the necessity of depressing the push-button. Further, like the above patents, Dove fails to disclose the use of an oval-shaped button, such that the extension is more easily attached to and removed from the implement.

Thus, in order to address these and other issues, there remains a long felt need in the art for an attachment mechanism for extension handles that allows the extension to be easily attached to the handle, without the need to depress a button, and features an oval shaped pin lock that maintains the position of the handle while allowing the extension handle to remain easily attachable and removable.

### SUMMARY OF THE INVENTION

Various embodiments of the invention are directed towards overcoming the above shortcomings by disclosing a mechanism for attaching extension handles to mops, brooms, and the like that features a novel configuration of pin lock that allows the extension to be attached to an implement without the need to depress the pin lock on attachment.

One embodiment of the invention comprise an extension handle that is insertable into the handle of an implement in order to extend the length of the implement's handle. For example, the invention may be used to extend the length of a mop handle, broom handle, tool handle or similar such implement. The implement handle features a proximal end and a distal end, the proximal end being configured to mount the implement. The extension handle also features a proximal end and a distal end, the distal end of the extension handle being configured for insertion into the distal end of the implement handle. The distal end of the implement handle features an opening, such that the distal end of the extension handle may be inserted into the implement handle.

The distal end of the extension handle is insertable because it is configured to feature a smaller diameter than that of the opening at the distal end of the implement handle. The inside diameter of the distal end of the implement handle is configured to be of a only slightly larger diameter than that of the outside diameter of the distal end of the extension handle such that the extension handle achieves a tight fit with the implement handle.

The length of the section of the distal end of the extension handle that is insertable into the distal end of the implement handle can be adjusted in various embodiments of the invention to accommodate particular applications.

Various embodiments of the invention further comprise an engagement mechanism that removably attaches the implement handle to the extension handle. Portions of the engagement mechanism are contained both on the implement handle and on the extension handle. In various embodiments of the invention, the distal end of the implement handle features an aperture at the portion of the implement handle that is configured to receive the inserted portion of the distal end of the extension handle. The aperture is shaped and configured to snugly house a pin lock mechanism that forms a portion of the engagement mechanism that is part of the extension handle.

The distal end of the extension handle features a pin lock mechanism that is configured to engage with the aperture at the distal end of the implement handle. In various embodiments of the invention, the pin lock mechanism comprises a pin that that is configured to engage with the aperture at the distal end of the implement handle.

The pin, of various embodiments of the invention, features a novel shape. First, the top side of the pin features a slope that angles toward the edge of the distal end of the extension handle. This sloped top configuration allows the pin lock mechanism to engage with the aperture of the implement handle without the need for the user to manually depress the pin. Also, the pin, in various embodiments of the invention, features a novel oval or rounded edge shape. The oval shaped pin allows the pin to engage with the aperture with a minimal effort by the user. Similarly, in various embodiments of the invention that use a generally rectangular-shaped pin that features rounded edges, the rounded edges allow the pin to smoothly, and relatively effortlessly, engage with the aperture. In this manner, the novel configuration of the pin allows the extension handle to be more easily coupled to the implement handle than other prior art devices.

The pin lock mechanism further features a spring mechanism that presses the pin outwards. In various embodiments of the invention, the spring mechanism comprises a pin that is located within the extension handle and serves to apply pressure on the pin upwards. The use of a novel shape for the pin and the spring allows the pin to engage with the aperture in order that the implement handle may be removably connected to the extension handle.

It further remains within the contemplation of the invention that it to be used with varying types of implements and extension handles. Extension handles of varying lengths, materials, and types remain within the contemplation of the invention. Telescoping handles of varying types also may be used with the various embodiments of the invention. Also, the principles of the invention may be practiced with implements and implement handles of various types. The principles of the invention may, for example, be practiced with household, industrial, and construction implements and their related extension handles, including but not limited to: brooms, mops, specialty mops, window squeegees, floor squeegees, window cleaners, floor sponges, window sponges, trowels, dust pans, dust mops, scrapers, bulb changers, dusters, feather dusters, brushes, carpet sweepers, and further such devices known in the art.

### BRIEF DESCRIPTION OF THE DRAWINGS

FIG. 1 is an illustration from a perspective view of one embodiment of the invention as completely assembled.

FIG. 2 is an illustration of an exploded view of one embodiment of the invention as assembled.

FIG. 3 is an illustration from a perspective view of one embodiment of the invention.

FIG. 4 is an illustration from a top view of one embodiment of the invention.

FIG. 5 is an illustration from a cross-sectional view of one embodiment of the invention.

FIG. 6 is an illustration from a perspective view of one embodiment of the extension handle pin portion of the pin lock mechanism used in one embodiment of the invention.

### DETAILED DESCRIPTION OF THE DRAWINGS

In the following detailed description of various embodiments of the invention, numerous specific details are set forth in order to provide a thorough understanding of various aspects of one or more embodiments of the invention. However, one or more embodiments of the invention may be practiced without these specific details. In other instances, well-known methods, procedures, and/ or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive. Also, the reference or non-reference to a particular embodiment of the invention shall not be interpreted to limit the scope the invention. Various embodiments of the invention remain useable in tandem or combination of one another.

In the following description, certain terminology is used to describe certain features of one or more embodiments of the invention. For instance, “implement” refers to any of the various household, industrial, and construction implements and their related handles, including but not limited to: brooms, mops, specialty mops, window squeegees, floor squeegees, window cleaners, floor sponges, window sponges, trowels, dust pans, dust mops, scrapers, bulb changers, dusters, feather dusters, brushes, carpet sweepers, and further such devices known in the art; “extension handle” refers to any of the various fixed-length, variable-length, or telescoping extension handles known in the art.

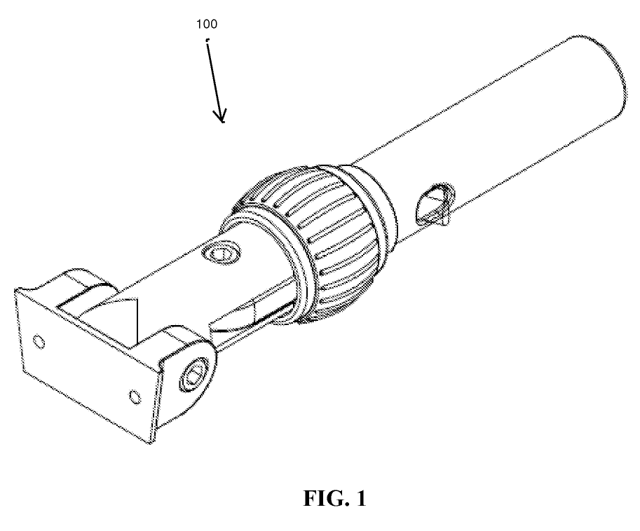

FIG. 1 is an illustration from a perspective view of one embodiment of the invention as completely assembled.

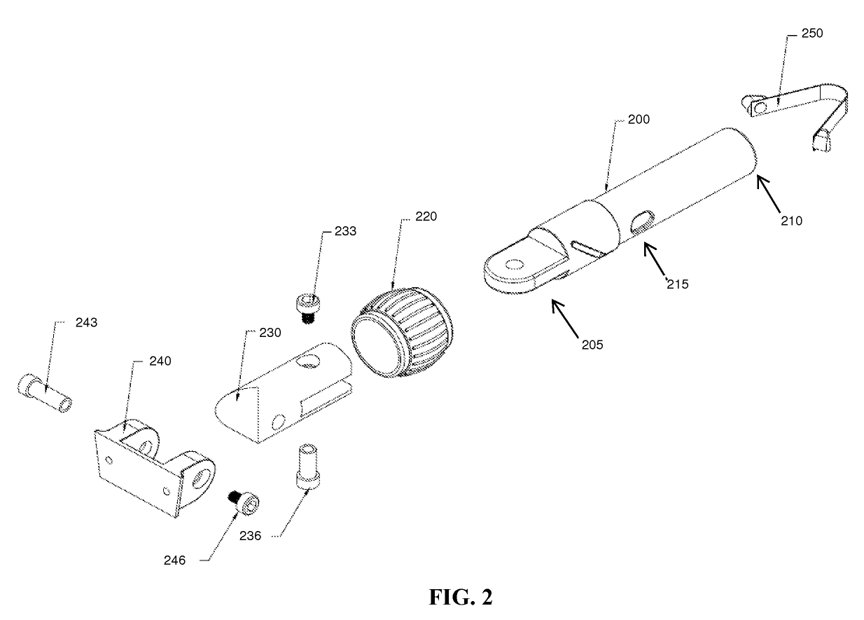

FIG. 2 is an illustration of an exploded view of one embodiment of the invention as assembled. An implement handle 200 having a proximal end 205 and a distal end 210 is illustrated. The implement handle 200 features an aperture 215 between the proximal end 205 and the distal end 210, which is configured to releasably engage with an extension handle pin 250. FIG. 2 also shows the locking ring 220, the lower swivel 230, screws 233 and 243 and nuts 236 and 246 and the swivel base 240 for connecting to the lower swivel 230.

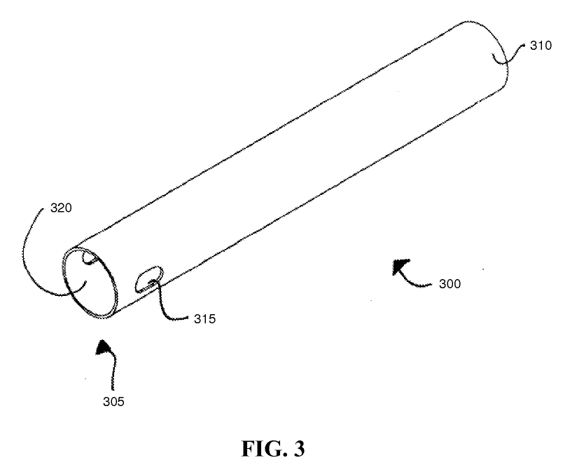

FIG. 3 is an illustration from a perspective view of one embodiment of the invention. An implement handle 300 having a proximal end 305 and a distal end 310 is illustrated. The implement handle 300 features an opening 320 near the proximal end 305, which allows the insertion of an extension handle into the implement handle 300. The implement handle 300 further features an aperture 315, which is configured to releasably engage with an extension handle pin (not shown in this figure).

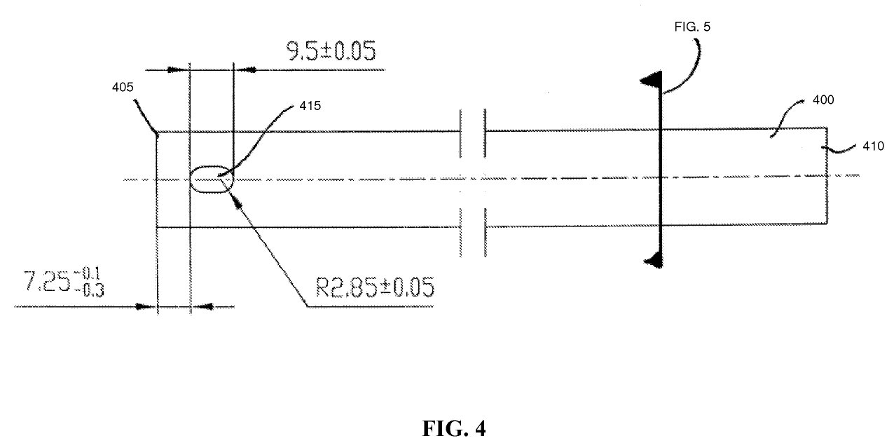

FIG. 4 is an illustration from a top view of one embodiment of the invention. An implement handle 400 having a proximal end 405 and a distal end 410 is illustrated. The implement handle 400 further features an aperture 415 between proximal end 405 and distal end 410, which is configured to releasably engage with an extension handle pin. In various embodiments of the invention, the aperture 415 may be oval-like in shape.

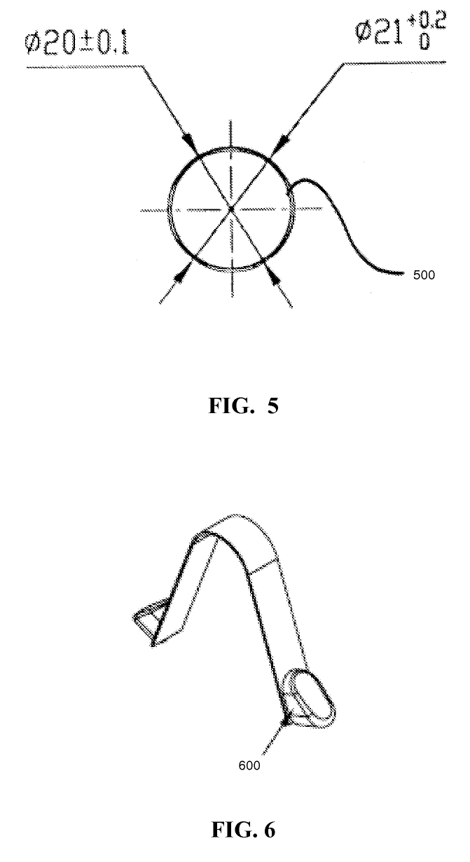

FIG. 5 is an illustration from a cross-sectional view of one embodiment of the invention. The implement handle 500 is shown from a cross-sectional perspective to be generally circular in cross-section.

FIG. 6 is an illustration from a perspective view of one embodiment of the extension handle pin portion 600 of the pin lock mechanism used in one embodiment of the invention.

What is claimed is:

1. An engagement mechanism for detachably coupling an implement handle to an extension handle, comprising:
an implement handle, said implement handle having a proximal end and a distal end, the proximal end of said implement handle being configured to support an implement,
the distal end of said implement handle being configured to be detachably coupled to said extension handle, featuring an opening for the insertion of said extension handle into the generally hollow portion of said distal end of said implement handle, and featuring an aperture,
said aperture comprising an opening in said distal end of said implement handle that releasably engages with a pin and said aperture being configured to circumscribe said pin when engaged,
said extension handle having a proximal end and a distal end, the distal end of said extension handle being configured to be detachably coupled to said implement handle, configured such that said pin protrudes axially from said distal end of extension handle, and housing a spring that applies pressure to said pin,
said pin generally having a top and side surfaces, the top surface of said pin being generally slanted downwards toward the distal end of said extension handle such that the protrusion of said pin is minimal at the portion of the pin that is closest to the distal end of said extension handle, and the side surfaces of said pin being generally oval-like in shape, and
said spring being configured to pressure said pin axially outwards.

2. An engagement mechanism for detachably coupling an implement handle to an extension handle, comprising:
an implement handle, said implement handle having a proximal end and a distal end, the proximal end of said implement handle being configured to support an implement,
the distal end of said implement handle being configured to be detachably coupled to said extension handle, featuring an opening for the insertion of said extension handle into the generally hollow portion of said distal end of said implement handle, and featuring an aperture,
said aperture comprising an opening in said distal end of said implement handle that releasably engages with a pin and said aperture being configured to circumscribe said pin when engaged,
said extension handle having a proximal end and a distal end, the distal end of said extension handle being configured to be detachably coupled to said implement handle, configured such that said pin protrudes axially from said distal end of extension handle, and housing a spring that applies pressure to said pin,
said pin generally having a top and side surfaces, the top surface of said pin being generally slanted downwards toward the distal end of said extension handle such that the protrusion of said pin is minimal at the portion of the pin that is closest to the distal end of said extension handle, and the side surfaces of said pin being generally rectangular in shape and featuring rounded corners, and
said spring being configured to pressure said pin axially outwards.

3. An engagement mechanism for detachably coupling an implement handle to an extension handle according to claim 1, wherein said extension handle comprises a telescoping extension handle.

4. An engagement mechanism for detachably coupling an implement handle to an extension handle according to claim 2, wherein said extension handle comprises a telescoping extension handle.

5. An engagement mechanism for detachably coupling an implement handle to an extension handle according to claim 1, wherein said implement handle and said extension handle are configured such that their cross-sectional shape is circular.

6. An engagement mechanism for detachably coupling an implement handle to an extension handle according to claim 2, wherein said implement handle and said extension handle are configured such that their cross-sectional shape is circular.

7. An engagement mechanism for detachably coupling an implement handle to an extension handle according to claim 5, wherein the outside diameter of the distal end of said extension handle is less than the inside diameter of the distal end of said implement handle.

8. An engagement mechanism for detachably coupling an implement handle to an extension handle according to claim 6, wherein the outside diameter of the distal end of said extension handle is less than the inside diameter of the distal end of said implement handle.

9. An engagement mechanism for detachably coupling an implement handle to an extension handle according to claim 1, wherein the implement handle supports an implement selected from the following group of: brooms, mops, specialty mops, window squeegees, floor squeegees, window cleaners, floor sponges, window sponges, trowels, dust pans, dust mops, scrapers, bulb changers, dusters, feather dusters, brushes, and carpet sweepers.

10. An engagement mechanism for detachably coupling an implement handle to an extension handle according to claim 2, wherein the implement handle supports an implement selected from the following group of: brooms, mops, specialty mops, window squeegees, floor squeegees, window cleaners, floor sponges, window sponges, trowels, dust pans, dust mops, scrapers, bulb changers, dusters, feather dusters, brushes, and carpet sweepers.

11. An engagement mechanism for detachably coupling an implement handle to an extension handle according to claim 1, wherein said extension handle further comprises a handgrip.

12. An engagement mechanism for detachably coupling an implement handle to an extension handle according to claim 2, wherein said extension handle further comprises a handgrip.

13. An engagement mechanism for detachably coupling an implement handle to an extension handle according to claim 11, wherein said handgrip may be variably positioned to cover the joint where said extension handle attaches to said implement handle.

14. An engagement mechanism for detachably coupling an implement handle to an extension handle according to claim 12, wherein said handgrip may be variably positioned to cover the joint where said extension handle attaches to said implement handle.
